(19) United States
(12) Patent Application Publication
(10) Pub. No.: US 2022/0143713 A1
(43) Pub. Date: May 12, 2022

(54) CUTTING INSERT AND TOOL HAVING SUCH A CUTTING INSERT

(71) Applicant: Hartmetall-Werkzeugfabrik Paul Horn GmbH, Tuebingen (DE)

(72) Inventors: Marc STEINHILBER, Mössingen (DE); Hans SCHÄFER, Gomaringen (DE)

(21) Appl. No.: 17/585,084

(22) Filed: Jan. 26, 2022

Related U.S. Application Data
(63) Continuation of application No. PCT/EP2020/072175, filed on Aug. 6, 2020.

(30) Foreign Application Priority Data
Aug. 8, 2019 (DE) 10 2019 121 468.8

(51) Int. Cl. B23B 27/16

(52) U.S. Cl. CPC B23B 27/1607

(57) ABSTRACT

Cutting insert for a tool for machining. The cutting insert is particularly suitable for grooving tools for grooving turning. The cutting insert has a chip breaker geometry in its cutting region, which enables both machining of full cuts and machining of partial cuts as well as machining of webs. In particular, due to the shape of a chip cavity provided in the cutting region and due to the presence of a negative chamfer, very short chips can be produced in all three machining variants, so that a high level of process reliability is ensured and long tool lives are made possible.

### CROSS-REFERENCE TO RELATED APPLICATIONS

This application is a continuation of international patent application PCT/EP2020/072175, filed on Aug. 6, 2020 designating the U.S., which international patent application has been published in German language and claims priority from German patent application DE 10 2019 121 468.8, filed on Aug. 8, 2019. The entire content of these priority applications are incorporated herein by reference.

### BACKGROUND

This disclosure relates to a cutting insert for a tool for machining. The disclosure further relates to a tool having such a cutting insert, and a tool holder which has at least one cutting insert receptacle for receiving the cutting insert.

The herein presented cutting insert is preferably a cutting insert which can be used for machining by turning. Particularly preferably, the cutting insert is suitable for machining by plunge turning.

A cutting insert, which was developed in particular for plunge turning, is disclosed in DE 100 42 692 A1. Although this cutting insert has proved quite advantageous in practice, over time several disadvantages have been found which offer room for improvement potential.

The cutting insert known from DE 100 42 692 A1, because of the chip form geometry, i.e. because of the form of the rake face in the cutting region of the cutting insert, is suitable only for so-called full cuts in which the tool plunges into the workpiece over the entire width of the main cutting edge of the cutting insert.

The cutting insert disclosed in DE 100 42 692 A1 is however less suited for part cuts, in which the workpiece is machined only with a part portion of the main cutting edge. Part cuts can indeed be created with this cutting insert, but the chip formation occurring is less advantageous than in a full cut in which the tool plunges into the workpiece over the entire width or length of the main cutting edge. The reason for this lies in particular in the specific design of the geometry of the cutting region.

The cutting region here is not only the region of the cutting edge itself but the entire region of the cutting insert which has an influence on chip formation during machining of the workpiece. The cutting region includes, as well as the main cutting edge, also the rake face and the secondary cutting edges.

For example, with the cutting insert disclosed in DE 100 42 692 A1, it has been found that in the machining of part cuts, the chip does not break as desired. Comparatively long chips are formed. This adversely affects the process reliability since the workpiece and/or the tool may be damaged by the relatively long chips.

### SUMMARY

It is an object to provide a cutting insert with a wider versatility, in that it is suitable not only for plunge turning with full cuts but also for plunge turning with part cuts. In particular, the chip formation properties of the cutting insert should be improved irrespective of whether the entire main cutting edge comes into contact with the workpiece (full cut) or only a part portion of the main cutting edge comes into contact with the workpiece (part cut).

According to a first aspect, a cutting insert is provided, comprising:
a main cutting edge which is configured so as to be rectilinear and runs orthogonally to a longitudinal direction of the cutting region;
a chamfer having three part regions which are all arranged in a common chamfer plane, wherein a first of the three part regions is arranged adjacent to a first end of the main cutting edge, a second of the three part regions extends along at least a majority of the main cutting edge and parallel thereto, and a third of the three part regions is arranged adjacent to a second end of the main cutting edge;
a chip cavity configured as a recess which is laterally delimited by the first and the third part regions of the chamfer, is delimited at its front end region facing the main cutting edge by the second part region of the chamfer, and is delimited in its opposite rear region by a wall;

wherein the chip cavity including the wall is arranged mirror-symmetrically to a plane of symmetry which is oriented orthogonally to the main cutting edge and runs through a center point of the main cutting edge,

wherein the chip cavity including the wall is arranged below the chamfer plane and does not intersect the chamfer plane,

wherein the wall comprises five wall regions which adjoin one another in incremental order and in sequence, wherein a first of the five wall regions and a fifth of the five wall regions are configured so as to be mirror-symmetrical to one another relative to the plane of symmetry, wherein a second of the five wall regions and a fourth of the five wall regions are configured so as to be mirror-symmetrical to one another relative to the plane of symmetry, and wherein a third of the five wall regions is divided into two mirror-symmetrical halves by the plane of symmetry,

wherein a profile line of the wall, which results from an intersection of the wall with an imaginary plane oriented orthogonally to the plane of symmetry and running along the longitudinal direction, has a first part portion arranged in the first wall region, a second part portion arranged in the second wall region, a third part portion arranged in the third wall region, a fourth part portion arranged in the fourth wall region, and a fifth part portion arranged in the fifth wall region,

wherein the first, third and fifth part portions are each concave, and wherein the second and fourth part portions are rectilinear or convex, and

wherein at least one point on the first part portion has a smaller distance from the main cutting edge than all points on the second, third and fourth part portions, and wherein all points on the second and fourth part portions have a smaller distance from the main cutting edge than all points on the third part portion.

According to a second aspect, a tool for machining a workpiece is provided, which comprises a cutting insert of the type mentioned above and a tool holder having at least one cutting insert receptacle for receiving the cutting insert.

A feature of the cutting insert is the above-mentioned chamfer which is divided into three part regions and extends at least partially around the chip cavity. The three part regions of the chamfer are all arranged in the same chamfer plane which is oriented obliquely upward relative to the longitudinal direction of the cutting region.

Because of this orientation, the chamfer plane does not intersect the chip cavity. The chamfer plane as a whole lies above the chip cavity. The chamfer is therefore oriented at a negative rake angle relative to the xy plane. This is also described as a negative chamfer. In particular, the part regions of the chamfer adjoining the two ends of the main cutting edge (first part region and third part region) ensure a stabilization of the cutting corners of the cutting insert. The second part region of the chamfer, which extends along a majority of the length of the main cutting edge, also contributes to stabilizing the main cutting edge. The negative chamfer therefore stabilizes the main cutting edge over its entire length or over the entire width of the cutting insert.

A further feature of the cutting insert is the chip cavity which adjoins the described negative chamfer. Within this chip cavity, a plurality of rake faces are arranged, the geometry of which is decisive for the chip formation. In its rear region, the chip cavity is delimited by a wall. This wall has five wall regions which directly adjoin one another in incremental order. The term “incremental order” here means that the second wall region adjoins the first wall region, the third wall region adjoins the second wall region, the fourth wall region adjoins the third wall region, and the fifth wall region adjoins the fourth wall region.

Because of the mirror-symmetry of the chip cavity relative to the plane of symmetry, the middle third wall region is divided by the imaginary plane of symmetry into two equal-sized halves which are mirror-symmetrical to one another. The first wall region is mirror-symmetrical to the fifth wall region, and the second wall region is mirror-symmetrical to the fourth wall region. All five wall regions are preferably configured as a free-form faces.

The profile line of the wall resulting from an intersection of the wall with an imaginary plane, which is oriented orthogonally to the plane of symmetry and runs along the longitudinal direction, has the following properties: the first, third and fifth part portions of this profile line are each configured so as to be concave. The second and fourth part portions of the profile line are each configured so as to be rectilinear or convex. At least one point on the first part portion of the profile line has a smaller distance from the main cutting edge than all points on the second, third and fourth part portions of the profile line. Because of the symmetry properties of the chip cavity, thus also at least one point on the fifth part portion of the profile line has a smaller distance from the main cutting edge than all points on the second, third and fourth part portions of the profile line. Furthermore, all points on the second and fourth part portions of the profile line have a smaller distance from the main cutting edge than all points on third part portion of the profile line.

In other words, or to put it more simply, the third wall region arranged centrally in the chip cavity is furthest from the main cutting edge. The two second and fourth wall portions of the chip cavity, which lie further out and adjoin this at the side, are arranged slightly closer to the main cutting edge than the third wall region. The two outermost wall regions (first and fifth wall regions) however are closest to the main cutting edge. As already stated, these distance relationships need not necessarily apply to the entire wall region, but at least to a respective one point on these wall regions.

The described form of the chip cavity, in particular the described form of the wall, together with the above-described negative chamfer, leads to significantly improved chip formation properties during machining of a workpiece with the cutting insert.

Experiments by the applicant have shown that excellent chip formation properties are achieved both on use of the cutting insert for a full cut and also on use of the cutting insert for a part cut. So-called web plunge machining, in which a web present on the workpiece is machined solely by a centrally arranged part portion of the main cutting edge, is also possible with the cutting insert.

Said web plunge machining differs from the above-mentioned part-cut plunge machining in that the part portion of the main cutting edge used for machining the workpiece in web plunge machining lies in the central region of the main cutting edge, and is preferably arranged symmetrically to the plane of symmetry, whereas the part portion of the main cutting edge used for machining the workpiece in part-cut plunge machining extends from one end of the main cutting edge to an arbitrary point which preferably lies between the center and the other end of the main cutting edge. In part-cut plunge machining, the cutting insert is thus typically loaded asymmetrically relative to the plane of symmetry of the chip cavity.

In a full cut, in which the entire main cutting edge is used for machining the workpiece, in particular the first and third part regions of the negative chamfer contribute to stabilizing the cutting corners. This allows long service lives. The middle region of the rear wall of the chip cavity, i.e. the second, third and fourth wall regions, are not loaded or at least only minimally loaded in full cutting. The second, third and fourth wall regions of the rear wall of the chip cavity therefore have no or at least only very slight influence on machining during a full cut. The first and third part regions of the negative chamfer, together with the first and fifth wall regions of the rear wall of the chip cavity, contribute to chip tapering on a full cut. The chip removed from the workpiece can therefore flow very easily out of the machining groove. This allows the formation of spiral chips with small chip space counts.

In a part cut, typically one of the part regions of the negative chamfer, which are situated in the region of the corners of the cutting insert (i.e. either the first part region or the third part region of the chamfer), is loaded. In addition to this one part region of the negative chamfer, on a part cut, an opposite wall region of the rear wall of the chip cavity is loaded. Depending on the side of the cutting insert on which the part cut is made, the functional faces in a part cut are for example the first part region of the negative chamfer together with the fourth wall region of the chip cavity or, on the other side, the second part region of the negative chamfer together with the fourth wall region of the chip cavity. Said wall regions of the chip cavity serve to balance said regions of the negative chamfer. Thus the formation of long spiral chips is also minimized on a part cut. Thus even on a part cut, good chip control and long service lives can be achieved.

In web plunge machining, in which a centrally arranged part portion of the main cutting edge is used for machining the workpiece, the chip formation is substantially influenced by the centrally arranged third wall region of the rear wall of the chip cavity. As already stated, in comparison with the other wall regions, this is furthest away from the main cutting edge and configured so as to be concave. Thus the removed chips roll up to one side in web plunge machining and thus taper, which in turn promotes chip breakage and prevents long spiral chips. The second part region of the negative chamfer, extending along the majority of the main cutting edge, also contributes to stabilizing the main cutting edge during web plunge machining and thus avoids damage to the main cutting edge resulting from overload.

The design of the cutting regions of the cutting insert thus leads to very good chip formation properties, irrespective of whether the cutting insert is used for machining a full cut, a part cut or for web plunge machining.

According to a refinement, all points on the first part portion have a smaller distance from the main cutting edge than all points on the second, third and fourth part portions.

In other words, the first wall region of the rear wall of the chip cavity as a whole is arranged closer to the main cutting edge than the second, third and fourth wall regions of the rear wall of the chip cavity. Because of this symmetry properties of the chip cavity, this applies accordingly also to the fifth wall region. In the latter refinement therefore, all points on the fifth part portion of the profile line also have a smaller distance from the main cutting edge than all points on the second, third and fourth part portions of the profile line.

In the latter refinement therefore, the wall regions arranged furthest to the outside (first and fifth wall regions) have the smallest distance from the main cutting edge, and the centrally arranged wall region (third wall region) has the greatest distance from the main cutting edge. The distances of the wall regions in-between (second and fourth wall regions) are each greater than the distance between the third wall region and the main cutting edge, but smaller than the distances of the two outermost wall regions (first and fifth wall regions) from the main cutting edge.

According to a further refinement, the five part portions of the profile line each define a curve which is continuous and differentiable.

The individual part portions of the profile line are thus each preferably kink-free and uninterrupted. Also, the individual wall regions are preferably kink-free.

Preferably, however, the five wall portions do not merge into one another tangentially. Between the individual wall regions, i.e. at the transition from one wall region to the next, kinks or edges may occur. The individual wall regions are thus preferably clearly segmented from one another inside the chip cavity. This also contributes to the stability of the machining process and improves the chip formation properties which result from machining using the cutting insert.

According to a further refinement, the third part portion of the profile line is the longest in comparison with the other part portions of the profile line.

The centrally arranged third wall region thus preferably forms the greatest part of the rear wall of the chip cavity. This is advantageous in particular during web plunge machining.

According to a further refinement, the second part region of the negative chamfer preferably directly adjoins the main cutting edge.

This relieves the load on the main cutting edge and thus makes a positive contribution to its overall stability.

According to a further refinement, the first part portion of the profile line directly adjoins the first part region of the negative chamfer. Similarly, in this refinement, the fifth part portion of the profile line directly adjoins the third part region of the negative chamfer.

Accordingly, in this refinement, the first wall region of the chip cavity directly adjoins the first part region of the negative chamfer, and the fifth wall region of the chip cavity directly adjoins the third part region of the negative chamfer. The first and third part regions of the negative chamfer are preferably each configured as a planar face.

According to a further refinement, a first boundary line between the chip cavity and the first part region of the negative chamfer, viewed in top view, runs at a first angle α relative to the main cutting edge, wherein 30°≤α≤90°. Correspondingly, a second boundary line between the chip cavity and the second part region of the negative chamfer, viewed in top view, runs at a second angle α₂ relative to the main cutting edge, wherein α₂ is the counter angle to α.

According to a further refinement, a plurality of protrusions are arranged in the chip cavity and protrude upward from a base surface arranged in the chip cavity, wherein the protrusions are arranged parallel to one another in a row along the main cutting edge.

Respective relative depressions result between the individual protrusions. During machining of a workpiece, the main chip flow thus takes place in the intermediate space between the individual protrusions. The chip is thereby laterally compressed. This pre-deformation causes a stiffening of the chip even before the chip reaches the rear wall of the chip cavity. On reaching the rear wall of the chip cavity, the chip therefore breaks comparatively easily, which again contributes to the desirable creation of chips which are as short as possible.

The number of protrusions is preferably uneven. For example, three, five, seven or nine protrusions may be provided along the main cutting edge. Preferably, the protrusions are arranged at equal distances from one another along the main cutting edge and parallel thereto.

According to a further refinement, the protrusions directly adjoin the second part region of the negative chamfer which extends parallel to the main cutting edge and along a majority thereof. Particularly preferably, the protrusions each have a surface portion which lies in the chamfer plane.

The negative chamfer merges into the individual protrusions in the central region of the main cutting edge, i.e. preferably directly and tangentially. This increases the compression effect which is exerted, because of the protrusions, on the chip removed from the workpiece. This further contributes to as early as possible a chip breakage and hence to formation of chips which are as short as possible.

According to a further refinement, the chip cavity is configured so as to be concave in any section parallel to the plane of symmetry. In a section parallel to the plane of symmetry, the first and fifth wall regions are preferably curved more strongly than the second and fourth wall regions. In a section parallel to the plane of symmetry, the second and fourth wall regions are however preferably curved more strongly than the centrally arranged third wall region. The curvature of the individual wall regions, viewed in the longitudinal sections, thus preferably diminishes from the outer wall regions to the wall regions lying further towards the inside.

It is understood that the above-mentioned features and those to be explained below may be used not only in the combination given but also alone or in other combinations without leaving the spirit and scope of the present disclosure.

### BRIEF DESCRIPTION OF THE DRAWINGS

FIG. 1 shows a perspective view of a first exemplary embodiment of a cutting insert according to the disclosure;

FIG. 2 shows a perspective view of an exemplary embodiment of a tool according to the disclosure;

FIG. 3 shows a top view from above onto the first exemplary embodiment of the cutting insert illustrated in FIG. 1;

FIG. 4 shows a side view of the first exemplary embodiment of the cutting insert illustrated in FIG. 1;

FIG. 5 shows a detail view of the top view from above, shown in FIG. 3;

FIG. 6 shows the section B-B indicated in FIG. 4;

FIG. 7 shows the section A-A indicated in FIG. 3;

FIG. 8 shows the view of the cutting insert from FIG. 5, wherein further geometric relationships are marked;

FIG. 9 shows the view of the cutting insert from FIG. 6, wherein further geometric relationships are marked;

FIG. 10 shows the view of the cutting insert from FIG. 7, wherein further geometric relationships are marked;

FIG. 11 shows a second exemplary embodiment of the cutting insert in a top view from above, similar to that illustrated in FIGS. 5 and 8; and

FIG. 12 shows the second exemplary embodiment of the cutting insert in a sectional view, similar to that illustrated in FIGS. 6 and 9.

### DESCRIPTION OF PREFERRED EMBODIMENTS

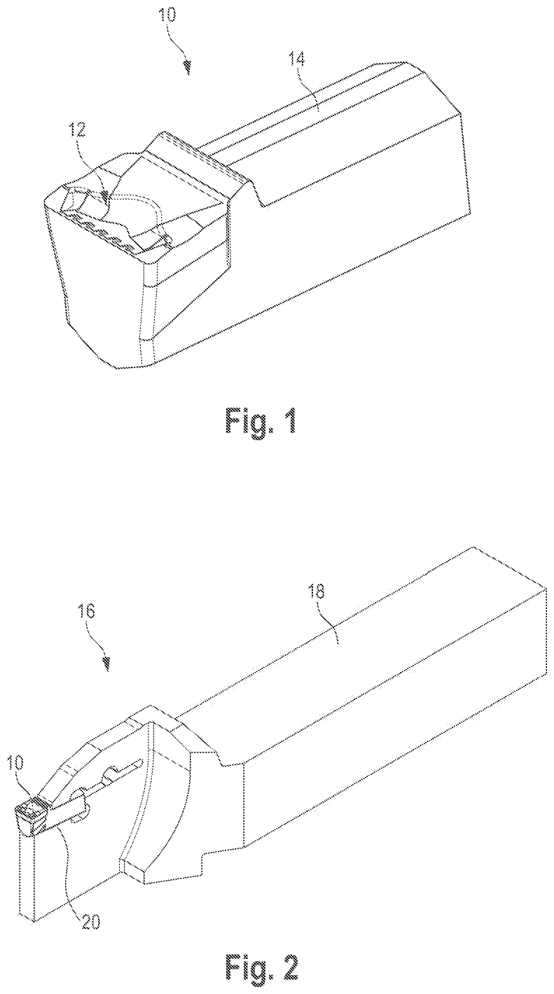

A first exemplary embodiment of the cutting insert is shown in a perspective view in FIG. 1. The cutting insert is designated as a whole with reference sign 10.

At its front end, the cutting insert 10 has a cutting region 12 which comes at least partially into contact with a workpiece during machining of the workpiece. The shape of this cutting region 12 is therefore essential for chip formation, i.e. the formation of chips removed from the workpiece.

In the rear region, the cutting insert 10 has a clamping portion 14. This clamping portion 14 serves for clamping the cutting insert 10 in a tool holder. The clamping portion 14 is configured as a web or bar and preferably has a polygonal or prismatic cross-section.

FIG. 2 shows an exemplary tool 16 in which the cutting insert may be used. The tool 16 shown in FIG. 2 is designed as a turning tool. This turning tool 16 is particularly suitable for plunge turning or grooving. It is however understood that the tool shown in FIG. 2 is merely an arbitrary example of a plurality of tools in which the cutting insert 10 may be used.

The tool 16 shown in FIG. 2 has a tool holder 18 which is designed substantially as a bar in its rear region, and has a cutting insert receptacle 20 in the region of its front end which serves for receiving the cutting insert 10. The cutting insert receptacle 20, in the exemplary embodiment shown in FIG. 2, is configured so as to be self-clamping so that no further fixing means are required for fixing the cutting insert 10 in the cutting insert receptacle 20. In a plurality of further known tool holders however, further fixing means, such as e.g. a clamping screw, are used for clamping the cutting insert 10 in the cutting insert receptacle 20. It is understood that this is also possible in principle with the tool 16 without leaving the spirit and scope of the present disclosure.

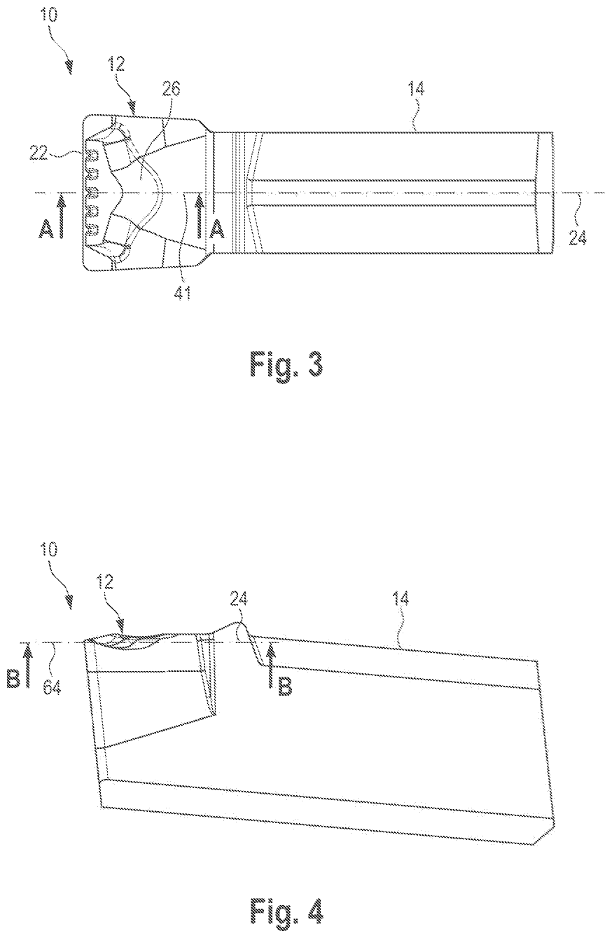

FIGS. 3 to 10 show further views of the cutting insert 10 according to the first exemplary embodiment shown in FIG. 1. As evident in particular from FIG. 3, on its front face end, the cutting insert receptacle 10 has a main cutting edge 22 which is configured so as to be rectilinear. The main cutting edge 22 runs orthogonally to a longitudinal direction of the cutting region 12. This longitudinal direction is shown as a dotted line in FIGS. 3 and 4 and marked with reference sign 24.

Furthermore, in the cutting region 12, the cutting insert 10 has a chip cavity 26. This chip cavity 26 is configured as a depression or material recess. It extends preferably over the majority of the width of the cutting region 12.

Furthermore, in the cutting region 12, a chamfer 28 is provided which, because of its orientation, is also known in the trade as a negative chamfer. The chamfer 28 is divided into three part regions 30a-30c. All three part regions 30a-30c of the chamfer 28 are arranged on a common flat plane. This plane is designated here as the “chamfer plane”. The chamfer plane is shown by a dotted line in FIG. 7 and carries reference sign 32. The chamfer plane 32 is oriented at an acute angle relative to the longitudinal direction 24 of the cutting region 12. Since this angle forms a negative rake angle, the chamfer 28 is generally also described as a negative chamfer, as already stated.

Because of the negative rake angle, the chamfer plane 32 protrudes upward beyond the chip cavity 26. The chip cavity 26 is thus arranged below the chamfer plane 32 and is not intersected thereby.

The chamfer 28 at least partially surrounds the chip cavity 26. The chamfer 28 preferably runs along the entire length of the main cutting edge 22. A first part region 31a of the chamfer 28 adjoins a first end 34a of the main cutting edge 22. The third part region 30c of the chamfer 28 adjoins the opposite end 34b of the main cutting edge 22. The two part regions 30a, 30c are designed as planar faces which form the two front corner regions of the cutting region 12.

Towards the front, the two part regions 30a, 30c are delimited by the main cutting edge 22. To the side, the two part regions 30a, 30c are delimited firstly at their respective inside by the chip cavity 26 and at their respective outside by a secondary cutting edge 36a, 36b. The two said secondary cutting edges 36a, 36b form the laterally outer ends of the cutting region 12. The secondary cutting edges 36a, 36b are each connected to the ends 34a, 34b of the main cutting edge 22 via a respective radius 38a, 38b. Instead of radii 38a, 38b, chamfers may also be provided as transitions between the secondary cutting edges 36a, 36b and the main cutting edge.

The second part region 30b of the chamfer 28 extends between the first part region 30a and the third part region 30c. This second part region 30b of the chamfer 28 extends along at least a majority of the main cutting edge 22 and runs parallel thereto. Preferably, the second part region 30b of the chamfer 28 directly adjoins the main cutting edge 22. This second part region 30b is also configured as a planar face which is arranged in one and the same chamfer plane 32 as the two planar faces formed by the part regions 30a, 30c.

At its front end facing the cutting edge 22, the chip cavity 26 is delimited by the second part region 30b of the chamfer 28. At its opposite rear end, the chip cavity 26 is delimited by a wall 40. This wall 40 forms the rear region of the chip cavity 26, viewed in the longitudinal direction 24. The wall 40 preferably extends over a majority (more than 50%) of the width of the cutting region 12.

As a whole, the chip cavity 26 is configured so as to be mirror-symmetrical to a plane of symmetry 41. This plane of symmetry 41 is shown as a dotted line in FIG. 3 and corresponds to the section plane A-A also marked in FIG. 3. The plane of symmetry 41 runs orthogonally to the main cutting edge 22 and has the same distance from both ends 34a, 34b of the main cutting edge 22. The plane of symmetry 41 thus runs through a center point of the main cutting edge 22.

Because of the symmetry properties of the chip cavity 26, accordingly the wall 40 is also configured so as to be mirror-symmetrical to the plane of symmetry 41. The wall 40 has five wall regions 42, 44, 46, 48, 50 which adjoin one another in incremental order and in sequence. The first wall region 42 is configured so as to be mirror-symmetrical to the fifth wall region 50. These two wall regions 42, 50 form the respective outer end regions of the wall 40. The second wall region 44 is arranged adjoining the first wall region 42. Correspondingly, the fourth wall region 48 is arranged adjoining the fifth wall region 50 and is designed mirror-symmetrically to the second wall region 42. The third wall region 46 is arranged between the second wall region 44 and the fourth wall region 48 and, in the width direction of the cutting insert 10, i.e. viewed transversely to the longitudinal direction 24, forms the middle region of the wall 40. Preferably, this third wall region 46 is superficially the largest of the five wall regions 42-50. The third wall region 46 is divided by the plane of symmetry 41 into two equal-sized, mirror-symmetrical halves.

A profile line 62, which is illustrated in FIG. 6, serves below for a more detailed explanation of the individual wall regions 42-50 of the wall 40. This profile line 62 results from a section along the section plane B-B marked in FIG. 4. This section plane B-B corresponds to an imaginary plane 64, which is oriented orthogonally to the plane of symmetry 41 and runs parallel to the longitudinal direction 24 of the cutting region 12.

Correspondingly to the five wall regions 42-50 of the wall 40, the profile line 62 also has five part portions 52, 54, 56, 58, 60. The first part portion 52 of the profile line 62 results from the intersection of the imaginary plane 64 with the first wall region 42. The second part portion 54 of the profile line 62 results from the intersection of the imaginary plane 64 with the second wall region 44. The third part portion 56 of the profile line 62 results from the intersection of the imaginary plane 64 with the third wall region 46. The fourth part portion 58 of the profile line 62 results from the intersection of the imaginary plane 64 with the fourth wall region 48. The fifth part portion 60 of the profile line 62 results from the intersection of the imaginary plane 64 with the fifth wall region 50.

Correspondingly, the five part portions 52-60 of the profile line 62, like the wall regions 42-50, adjoin one another in incremental order and in sequence. The first part portion 52 is configured so as to be mirror-symmetrical to the fifth part portion 60. The second part portion 54 is configured so as to be mirror-symmetrical to the fourth part portion 58. The third part portion 56 is divided by the plane of symmetry 41 into two equal-sized, mirror-symmetrical halves and forms the middle region of the profile line 62, which connects the second part portion 54 to the fourth part portion 58.

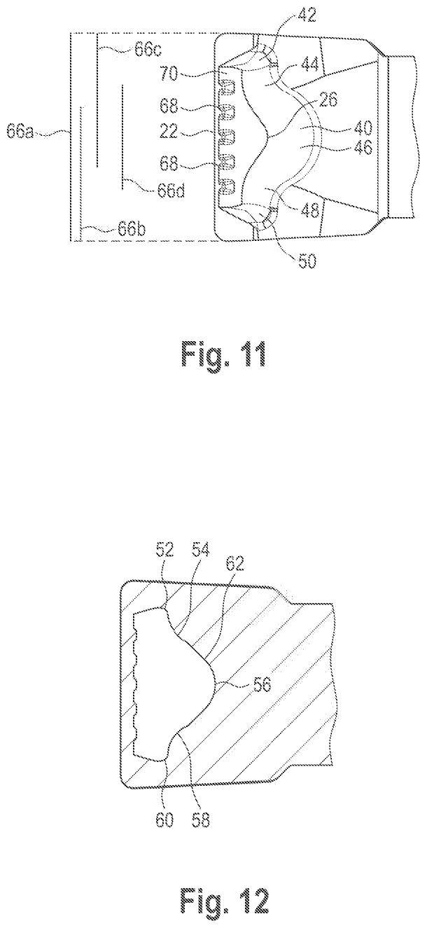

The first, third and fifth part portions 52, 56, 60 are each configured so as to be concave. The second and fourth part portions 54, 58 are each configured so as to be rectilinear or convex. In the sectional view of the first exemplary embodiment shown in FIG. 6, the second and the fourth part portions 54, 58 are each configured so as to be rectilinear. In the view of the cutting insert 10 according to the second exemplary embodiment, shown in FIG. 12, the second part portion 54 and the fourth part portion 58 are however each configured so as to be convex. Otherwise, the exemplary embodiment shown in FIGS. 11 and 12 does not differ from the first exemplary embodiment shown in FIGS. 3-7.

The first wall region 42 and the fifth wall region 50 of the wall 40, in comparison with the other wall regions 44, 46, 48, have the shortest distance from the main cutting edge 22. In any case, at least one point on the first part portion of the profile line 62 has a smaller distance from the main cutting edge 22 than all points on the second, third and fourth part portions 54, 56, 58 of the profile line 62. Preferably, all points on the first part portion 52 of the profile line 62 have a smaller distance from the main cutting edge 22 than all points on the second, third and fourth part portions 54, 56, 58 of the profile line 62.

It is understood that, because of the described symmetry properties of the chip cavity 26 or wall 40, the same distance relationships also apply with respect to the fifth wall region 50 or fifth part portion 60 respectively.

The third wall region 46 has the greatest distance from the main cutting edge 22. Correspondingly, all points on the second and fourth part portions 54, 58 of the profile line 62 have a smaller distance from the main cutting edge 22 than all points on the third part portion 56 of the profile line 62.

The individual part portions 52-60 of the profile line 62 are preferably each configured so as to be kink-free. They thus each form a curve which is continuous and differentiable.

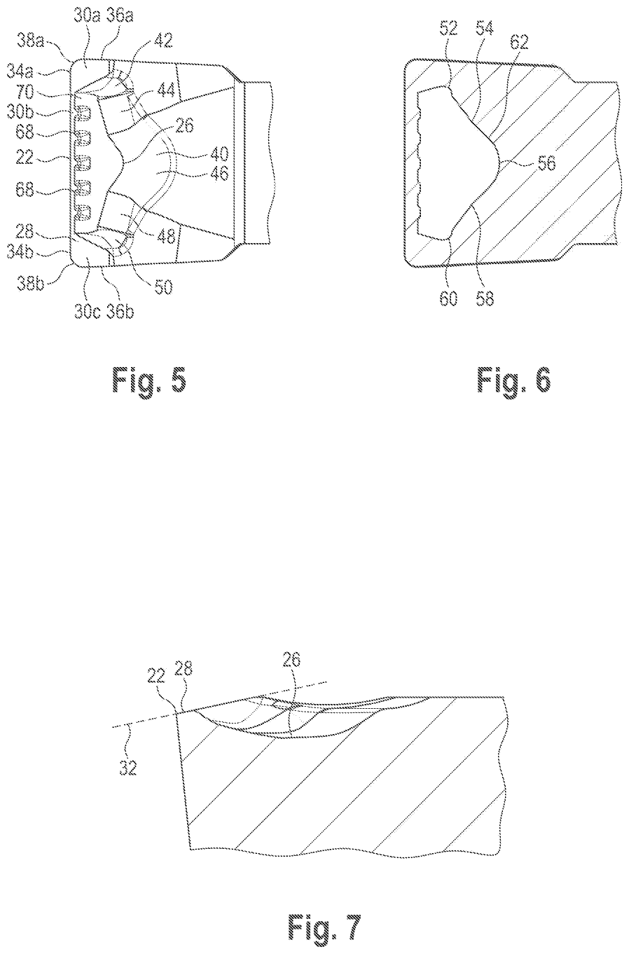

According to the first exemplary embodiments of the cutting insert 10 shown in FIGS. 5 and 6, the five wall regions 42-50 of the wall 40 do not merge into one another tangentially. Between the individual part portions 52-60 of the profile line 62, kinks thus occur at the respective transition points. According to the second exemplary embodiment of the cutting insert 10 shown in FIGS. 11 and 12, however, such kinks occur only between the first wall region 42 and the second wall region 44, and between the fourth wall region 48 and the fifth wall region 50. The second wall region 44 according to the second exemplary embodiment, however, merges tangentially into the third wall region 46. Similarly, according to the second exemplary embodiment, the third wall region 46 also merges tangentially into the fourth wall region 48.

Both exemplary embodiments described here of the cutting insert share the feature that the first and fifth part portions 52, 60 of the profile line 62 are preferably curved more strongly than the centrally arranged third part portion 56 of the profile line 62. Similarly, according to both exemplary embodiments shown, it is preferred that the centrally arranged third part portion 56 of the profile line 62 forms the comparatively longest of all five part portions 52-60.

As already explained in the introduction to the description, the cutting insert 10, in particular because of the described form of the chip cavity 26 and because of the presence of the negative chamfer 28, is suitable both for plunge machining of full cuts and also for plunge machining of part cuts and for the above-mentioned web plunge machining. To clarify the meanings of the different machining variants, a plurality of helper lines 66a-66d are shown in FIG. 11.

The helper lines 66b and 66c indicate the working region of the cutting insert 10 during a part cut. Here, the cutting insert 10 comes into contact with the workpiece to be machined only along a part portion of the main cutting edge 22. The helper line 66b indicates a part cut which extends starting from the second end 34b of the main cutting edge 22, or starting from the radius 38b, to an arbitrary point on the main cutting edge 22 which lies between the two ends 34a, 34b of the main cutting edge 22. The helper line 66c however indicates a part cut which extends starting from the first end 34a or the radius 38a to an arbitrary point on the main cutting edge 22 which is arranged between the two ends 34a, 34b of the main cutting edge 22. Preferably, 60-80% of the total length of the main cutting edge 22 is used for such part cuts.

The helper line 66d indicates an exemplary working region during web plunge machining. As the name indicates, during web plunge machining, the cutting insert 10 machines a web provided on the workpiece to be machined. This machining preferably takes place with a central region of the main cutting edge 22 which is symmetrical to the plane of symmetry 41. Depending on the width of the web to be machined, usually 10 60% of the total length of the main cutting edge 22 comes into engagement with the workpiece.

In a full cut, as indicated by the helper line 66a, a part of the chip removed from the workpiece runs over the part regions 30a and 30c of the negative chamfer 28 arranged in the cutting corners. These part regions 30a, 30c stabilize the cutting corners. The centrally arranged second part region 30b of the negative chamfer 28 stabilizes the central region of the main cutting edge 22. On a full cut, in which the entire main cutting edge 22 is used for machining the workpiece, in particular the first and the third part regions 30a, 30c of the negative chamfer 28 contribute to stabilizing the cutting corners. This allows long service lives. The middle region of the rear wall 40 of the chip cavity 26, i.e. the second, third and fourth wall regions 44, 46, 48, are not loaded or at least only minimally loaded during a full cut. The second, third and fourth wall regions 44, 46, 48 of the rear wall of the chip cavity 26 therefore have no or at least only a very slight influence on machining during a full cut.

During a part cut, as indicated by the helper line 66b, however, it is essentially the third part region 30c of the negative chamfer 28 and the second wall region 44 which act as functional faces and substantially influence the chip formation. A majority of the chip removed from the workpiece runs over these two mutually opposing faces 30c, 44. In this case too, because of the shape of the two faces 30c, 44, a lateral chip taper can be achieved so that even when machining a part cut, short spiral chips can be produced. The same applies to a part-cut machining as indicated by the helper line 66c. In this case, the first part region 30a of the negative chamfer 28 and the fourth wall region 48 act as mutually opposing functional faces which substantially influence the chip formation.

In the case of web plunge machining, as indicated for example by the helper line 66d, in particular the middle part of the wall 40, i.e. the concavely curved third wall region 46, is decisive for chip formation or chip forming. In particular, in this case, the second part region 30b of the negative chamfer 28 stabilizes the central region of the main cutting edge 22 which is in engagement with the workpiece to be machined. The concave curvature of the third wall region 46 of the wall 40 in turn ensures a lateral chip taper, which allows a comparatively early chip breakage and hence—even on web plunge machining—guarantees the formation of comparatively short chips.

To further improve the chip formation, in the cutting region 12 of the cutting insert 10, a plurality of protrusions 68 may be provided. In the two exemplary embodiments shown here of the cutting insert 10 according to the example, in total five of these protrusions 68 are arranged in the chip cavity 26. The protrusions 68 are arranged parallel to one another in a row along the main cutting edge 22. They protrude from a base surface 70 which is arranged in the chip cavity 26 and preferably configured as a planar face adjoining the second part region 30b of the negative chamfer 28.

Between the protrusions 68, relative depressions or channel-like passages are formed. The protrusions 68 therefore ensure a type of pre-deformation of the chip before it reaches the rear wall 40 of the chip cavity 26. This contributes to a further improved chip breakage and hence to the formation of even shorter chips. It is understood however that the cutting insert 10 may also be configured without the protrusions 68, without leaving the spirit and scope of the present disclosure.

Insofar as the protrusions 68 are provided on the cutting insert 10, it is preferred that they directly adjoin the second part region 30b of the negative chamfer 28. Particularly preferably, each of the protrusions 68 has a surface portion which lies in the chamfer plane 32. In other words, the protrusions 68 merge preferably tangentially into the second part region 30b of the negative chamfer 28. This contributes to further stabilizing of the main cutting edge 22.

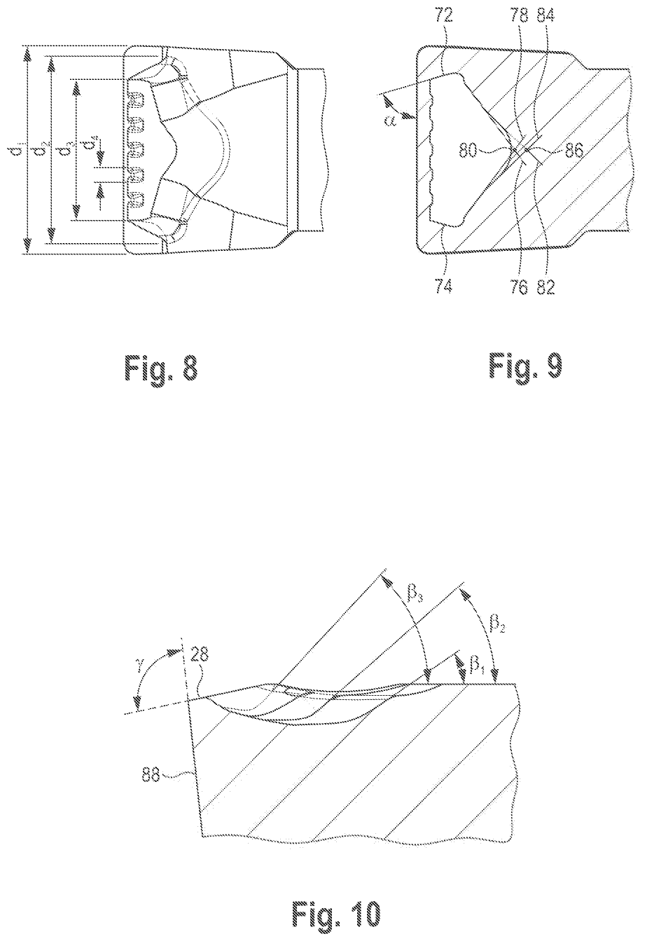

Further preferred size relationships and geometric designs of the chip cavity 26 are explained in more detail below with reference to FIGS. 8-10.

The width d₂ of the chip cavity 26 preferably amounts to 75-95% of the total width d₁ of the cutting insert 10 in the cutting region 12. The width d₃ of the second part region 30b of the negative chamfer 28, which corresponds to the width of the base surface 70, preferably amounts to 60-90% of the total width d₁ of the cutting insert 10 in the cutting region 12. Furthermore, the width d₄ of the protrusions 68 preferably amounts to 5-12% of the width d₃. Thus, preferably, d₁>d₂≥d₃>d₄.

As evident in particular from FIG. 9, the angle α which the main cutting edge 22 encloses with a boundary line 72, which extends between the chip cavity 26 and the first part region 30a of the chamfer 28, preferably amounts to 30°-90°. It is understood that the opposite boundary line 74, which extends between the third part region 30c of the chamfer 28 and the chip cavity, encloses the corresponding counter angle with the main cutting edge 22.

FIG. 9 furthermore shows a tangent 76 which touches the second part portion 54 of the profile line 62 at the transition point between the second part portion 54 and the third part portion 56. The marked tangent 78 touches the fourth part portion 58 of the profile line 62 at the transition point between the third part portion 56 and the fourth part portion 58. The tangents 76, 78 cross at a point 80. Furthermore, FIG. 9 shows the tangents 82 and 84. The tangent 82 touches the third part portion 56 of the profile line 62 at the transition point between the second part portion 54 and the third part portion 56. The tangent 84 touches the third part portion 56 of the profile line 62 at the transition point between the third part portion 56 and the fourth part portion 58. The tangents 82, 84 intersect at a point 86. This point 86 has a greater distance from the main cutting edge 22 than the point 80.

Furthermore, the longitudinal section illustrated in FIG. 10 shows that the chip cavity 26 preferably has a concave curvature in every section parallel to the plane of symmetry 41. Preferably, the second wall region 44 and the fourth wall region 48 are curved more strongly than the third wall region 46. This is illustrated amongst others by the angles β₁ and β₂ shown in FIG. 10. It is also preferred that the first wall region 42 and the fifth wall region 50 are each curved more strongly than the second wall region 44 and the fourth wall region 48 (see angle β₃). Preferably, therefore, β₃>β₂>β₁.

The main cutting edge 22 is formed at the transition between the chamfer 28 arranged in the chamfer plane 32 and a free face 88. This free face 88 forms the front end face of the cutting insert 10. This chamfer 28 is tilted by an angle γ relative to the free face 88, wherein γ≥90°. Particularly preferably, γ>90°.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.”, “for instance”, “such as”, and “like”, and the verbs “comprising”, “having”, “including” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A cutting insert for a tool for machining, wherein the cutting insert comprises in a cutting region:
a main cutting edge that is rectilinear and runs orthogonally to a longitudinal direction of the cutting region;
a chamfer having three part regions that are all arranged in a common chamfer plane, wherein a first of the three part regions is arranged adjacent to a first end of the main cutting edge, a second of the three part regions extends along at least a majority of the main cutting edge and parallel thereto, and a third of the three part regions is arranged adjacent to a second end of the main cutting edge;
a chip cavity configured as a recess which is laterally delimited by the first and the third part regions of the chamfer, is delimited at its front end region facing the main cutting edge by the second part region of the chamfer, and is delimited in its rear region opposite the front end region by a wall;
wherein the chip cavity including the wall is arranged mirror-symmetrically to a plane of symmetry that is oriented orthogonally to the main cutting edge and runs through a center point of the main cutting edge,
wherein the chip cavity including the wall is arranged below the chamfer plane and does not intersect the chamfer plane,
wherein the wall comprises five wall regions which adjoin one another in incremental order and in sequence, wherein a first of the five wall regions and a fifth of the five wall regions are configured so as to be mirror-symmetrical to one another relative to the plane of symmetry, wherein a second of the five wall regions and a fourth of the five wall regions are configured so as to be mirror-symmetrical to one another relative to the plane of symmetry, and wherein a third of the five wall regions is divided into two mirror-symmetrical halves by the plane of symmetry,
wherein a profile line of the wall, which results from an intersection of the wall with an imaginary plane oriented orthogonally to the plane of symmetry and running along the longitudinal direction, has a first part portion arranged in the first wall region, a second part portion arranged in the second wall region, a third part portion arranged in the third wall region, a fourth part portion arranged in the fourth wall region, and a fifth part portion arranged in the fifth wall region,
wherein the first, third and fifth part portions are each concave, and wherein the second and fourth part portions are rectilinear or convex, and
wherein at least one point on the first part portion has a smaller distance from the main cutting edge than all points on the second, third and fourth part portions, and
wherein all points on the second and fourth part portions have a smaller distance from the main cutting edge than all points on the third part portion.

2. The cutting insert as claimed in claim 1, wherein all points on the first part portion have a smaller distance from the main cutting edge than all points on the second, third and fourth part portions.

3. The cutting insert as claimed in claim 1, wherein the five part portions each define a curve which is continuous and differentiable.

4. The cutting insert as claimed in claim 1, wherein the five wall portions do not merge into one another tangentially.

5. The cutting insert as claimed in claim 1, wherein the first part portion is curved more strongly than the third part portion.

6. The cutting insert as claimed in claim 1, wherein the third part portion is longer than the first part portion, the second part portion, the fourth part portion, and the fifth part portion.

7. The cutting insert as claimed in claim 1, wherein the second part region of the chamfer directly adjoins the main cutting edge.

8. The cutting insert as claimed in claim 1, wherein the first part portion of the profile line directly adjoins the first part region of the chamfer, and wherein the fifth part portion of the profile line directly adjoins the third part region of the chamfer.

9. The cutting insert as claimed in claim 1, wherein a first boundary line between the chip cavity and the first part region of the chamfer, viewed in top view, runs at a first angle α relative to the main cutting edge, wherein 30°≤α≤90°.

10. The cutting insert as claimed in claim 1, wherein a plurality of protrusions are arranged in the chip cavity and protrude upward from a base surface arranged in the chip cavity, and wherein the protrusions are arranged parallel to one another in a row along the main cutting edge.

11. The cutting insert as claimed in claim 10, wherein the plurality of protrusions comprise an uneven number of protrusions.

12. The cutting insert as claimed in claim 10, wherein the protrusions directly adjoin the second part region of the chamfer.

13. The cutting insert as claimed in claim 10, wherein the protrusions each have a surface portion which lies in the chamfer plane.

14. The cutting insert as claimed in claim 1, wherein the chip cavity is configured so as to be concave in any section parallel to the plane of symmetry.

15. A tool for machining a workpiece, with a cutting insert and a tool holder which comprises at least one cutting insert receptacle for receiving the cutting insert, wherein the cutting insert comprises in a cutting region:
a main cutting edge that is rectilinear and runs orthogonally to a longitudinal direction of the cutting region;
a chamfer having three part regions that are all arranged in a common chamfer plane, wherein a first of the three part regions is arranged adjacent to a first end of the main cutting edge, a second of the three part regions extends along at least a majority of the main cutting edge and parallel thereto, and a third of the three part regions is arranged adjacent to a second end of the main cutting edge;
a chip cavity configured as a recess which is laterally delimited by the first and the third part regions of the chamfer, is delimited at its front end region facing the main cutting edge by the second part region of the chamfer, and is delimited in its rear region opposite the front end region by a wall;
wherein the chip cavity including the wall is arranged mirror-symmetrically to a plane of symmetry that is oriented orthogonally to the main cutting edge and runs through a center point of the main cutting edge,
wherein the chip cavity including the wall is arranged below the chamfer plane and does not intersect the chamfer plane,
wherein the wall comprises five wall regions which adjoin one another in incremental order and in sequence, wherein a first of the five wall regions and a fifth of the five wall regions are configured so as to be mirror-symmetrical to one another relative to the plane of symmetry, wherein a second of the five wall regions and a fourth of the five wall regions are configured so as to be mirror-symmetrical to one another relative to the plane of symmetry, and wherein a third of the five wall regions is divided into two mirror-symmetrical halves by the plane of symmetry,
wherein a profile line of the wall, which results from an intersection of the wall with an imaginary plane oriented orthogonally to the plane of symmetry and running along the longitudinal direction, has a first part portion arranged in the first wall region, a second part portion arranged in the second wall region, a third part portion arranged in the third wall region, a fourth part portion arranged in the fourth wall region, and a fifth part portion arranged in the fifth wall region,
wherein the first, third and fifth part portions are each concave, and wherein the second and fourth part portions are rectilinear or convex, and
wherein at least one point on the first part portion has a smaller distance from the main cutting edge than all points on the second, third and fourth part portions, and
wherein all points on the second and fourth part portions have a smaller distance from the main cutting edge than all points on the third part portion.
